(19) United States
(12) Patent Application Publication
(10) Pub. No.: US 2024/0185397 A1
(43) Pub. Date: Jun. 6, 2024

(54) METHOD AND DEVICE FOR APPLYING A BOKEH EFFECT TO IMAGE

(71) Applicant: SK hynix Inc., Icheon-si Gyeonggi-do (KR)

(72) Inventor: Yuuki Adachi, Icheon-si Gyeonggi-do (KR)

(73) Assignee: SK hynix Inc., Icheon-si Gyeonggi-do (KR)

(21) Appl. No.: 18/301,084

(22) Filed: Apr. 14, 2023

(30) Foreign Application Priority Data
Dec. 1, 2022 (KR) 10-2022-0165871

(51) Int. Cl. G06T 5/00; G06T 5/20; G06T 7/194; G06T 7/50; G06T 7/90; G06V 40/16

(52) U.S. Cl. CPC G06T 5/002; G06T 5/20; G06T 7/194; G06T 7/50; G06T 7/90; G06V 40/161; G06T 2207/10024; G06T 2207/10028; G06T 2207/30201

(57) ABSTRACT

An image processor determines a shape of a kernel applied to an image based on at least one of distance information or color information. The image processor generates a bokeh image in which at least a partial area of the image is blurred using the kernel.

### CROSS-REFERENCE TO RELATED APPLICATION

The present application claims priority under 35 U.S.C. § 119(a) to Korean patent application number 10-2022-0165871 filed on Dec. 1, 2022, in the Korean Intellectual Property Office, the entire disclosure of which is incorporated by reference herein.

### BACKGROUND

### 1. Technical Field

The present disclosure relates to a technology for applying a bokeh effect to an image through image processing.

### 2. Related Art

A camera such as a DSLR uses an imaging technique called out focus in which a main subject is highlighted by adjusting controlling a depth of field so that a background other than the main subject is blurred. However, recently, as a camera module mounted on a mobile device or the like is miniaturized, adjusting the depth of field is difficult, and thus an electronic device obtains an image similar to an out focus image through image processing for a captured image.

An electronic device applies a bokeh effect as image processing for the captured image. The electronic device generates an image to which the bokeh effect is applied (hereinafter, referred to as a bokeh image) by maintaining the main subject, to which focus is set, in the captured image to be clear and blurring the background other than the main subject.

For example, the electronic device may blur the background by performing a convolution operation on a background area of the image through a designated kernel.

### SUMMARY

An electronic device generally performs a convolution operation with a Gaussian kernel to apply a bokeh effect through image processing. However, because a point spread function (PSF) through an actual lens has a distribution different from that of a Gaussian function due to diffraction of the lens, the bokeh effect using the Gaussian kernel is different from that of an out focus image captured using the actual lens.

According to an embodiment of the present disclosure, an image processor may include a kernel determiner configured to determine a shape of a kernel applied to an image based on at least one of distance information or color information. The image processor may also include a kernel applier configured to output a bokeh image obtained by blurring at least a partial area of the image using the kernel.

According to an embodiment of the present disclosure, an image processing device may include a distance sensor configured to obtain distance information for a scene. The image processing device may also include an image sensor configured to capture an image of the scene. The image processing device may further include an image processor configured to determine a shape of a kernel applied to the image based on the distance information and color information of the image, generate a bokeh image obtained by blurring at least a partial area of the image using the kernel, and output the generated bokeh image.

According to an embodiment of the present disclosure, an image processing method may include obtaining distance information for a scene through a distance sensor. The method may also include capturing an image of the scene through an image sensor. The method may further include determining a shape of a kernel applied to the image based on the distance information and color information of the image. The method may additionally include generating a bokeh image in which at least a partial area of the image is blurred using the determined kernel.

According to the present disclosure, an electronic device may reproduce diffraction of an actual lens by applying a bokeh effect, and through this, the electronic device may obtain a bokeh image more similar to an out focus image captured using the actual lens.

### BRIEF DESCRIPTION OF THE DRAWINGS

FIG. 1 is a diagram illustrating a device according to an embodiment of the present disclosure.

FIG. 2 is a diagram illustrating an image sensor according to an embodiment of the present disclosure.

FIG. 3 is a diagram illustrating configurations included in a device according to an embodiment of the present disclosure.

FIG. 4 is a diagram illustrating a Fresnel kernel according to an embodiment of the present disclosure.

FIG. 5 is a diagram illustrating a cross section of a Fresnel kernel according to an embodiment of the present disclosure.

FIG. 6 is a diagram illustrating an example of a bokeh image generated according to an embodiment of the present disclosure.

FIG. 7 is a diagram illustrating a method of dividing a face area and a background area according to an embodiment of the present disclosure.

FIG. 8 is a flowchart illustrating a method of generating a bokeh image according to an embodiment of the present disclosure.

### DETAILED DESCRIPTION

Specific structural or functional descriptions of embodiments according to the concept which are disclosed in the present specification or application are illustrated only to describe the embodiments according to the concept of the present disclosure. The embodiments according to the concept of the present disclosure may be carried out in various forms and should not be construed as being limited to the embodiments described in the present specification or application.

In the present disclosure, each of phrases such as “A or B”, “at least one of A or B”, “at least one of A and B”, “A, B, or C”, “at least one of A, B, or C”, and “at least one of A, B, and C” may include any one of items listed in a corresponding phrase among the phrases, or all possible combinations thereof.

Hereinafter, embodiments of the present disclosure will be described with reference to the accompanying drawings to describe in detail enough to allow those of ordinary skill in the art to implement the technical idea of the present disclosure.

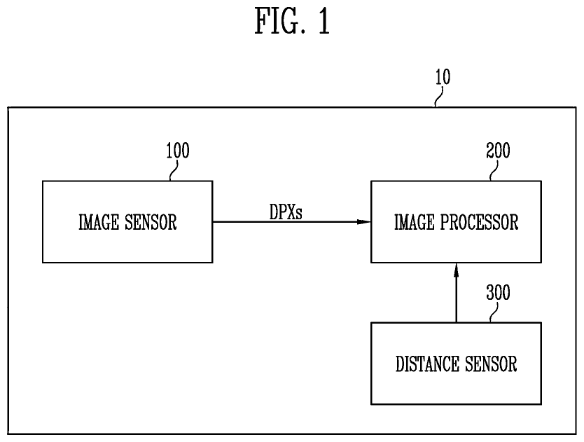

FIG. 1 is a diagram illustrating a device according to an embodiment of the present disclosure.

Referring to FIG. 1, the device 10 may include an image sensor 100, an image processor 200, and a distance sensor 300. For example, the device 10 may correspond to an electronic device a digital camera, a mobile device, a smart phone, a tablet PC, a personal digital assistant (PDA), an enterprise digital assistant (EDA), a digital still camera, a digital video camera, a portable multimedia player (PMP), a mobile internet device (MID), a personal computer (PC), a wearable device, or a device including a camera for various purposes. Alternatively, the device 10 of FIG. 1 may correspond to a part or a module (for example, a camera module) mounted in another electronic device. The device 10 may be referred to as an image processing device.

The image sensor 100 may be implemented as a charge coupled device (CCD) image sensor or a complementary metal oxide semiconductor (CMOS) image sensor. The image sensor 100 may generate image data for light incident through a lens (not shown). For example, the image sensor 100 may convert light information of a subject incident through the lens into an electrical signal and provide the electrical signal to the image processor 200. The lens may include at least one lens forming an optical system.

The image sensor 100 may include a plurality of pixels. The image sensor 100 may generate a plurality of pixel values DPXs corresponding to a captured scene through the plurality of pixels. The image sensor 100 may transmit the generated plurality of pixel values DPXs to the image processor 200. That is, the image sensor 100 may provide image data obtained through the plurality of pixels to the image processor 200.

The image processor 200 may perform image processing on the image data received from the image sensor 100. For example, the image processor 200 may perform at least one of interpolation, electronic image stabilization (EIS), color correction, image quality correction, or size adjustment on the image data. The image processor 200 may obtain image data of which quality is improved or image data to which an image effect is applied through the image processing.

The distance sensor 300 may measure a distance to an external object. For example, the distance sensor 300 may be a time-of-flight (TOF) sensor, and may identify the distance to the external object by using reflected light in which output modulated light is reflected by the external object. The device 10 may identify a distance of at least one object included in the scene which is being captured using the distance sensor 300, and generate a depth image including distance information for each pixel. As another example, the distance sensor 300 may be a stereo vision sensor, and may identify the distance to the external object using a disparity between scenes captured using two cameras. As still another example, the distance sensor 300 may be a deep learning module that estimates a depth through a monocular image. The monocular depth estimation module may obtain distance information or information corresponding to the distance to the external object by estimating a depth of a corresponding scene from one two-dimensional image. In addition, the distance sensor 300 may be variously configured to obtain distance information or the information on the distance to the external object.

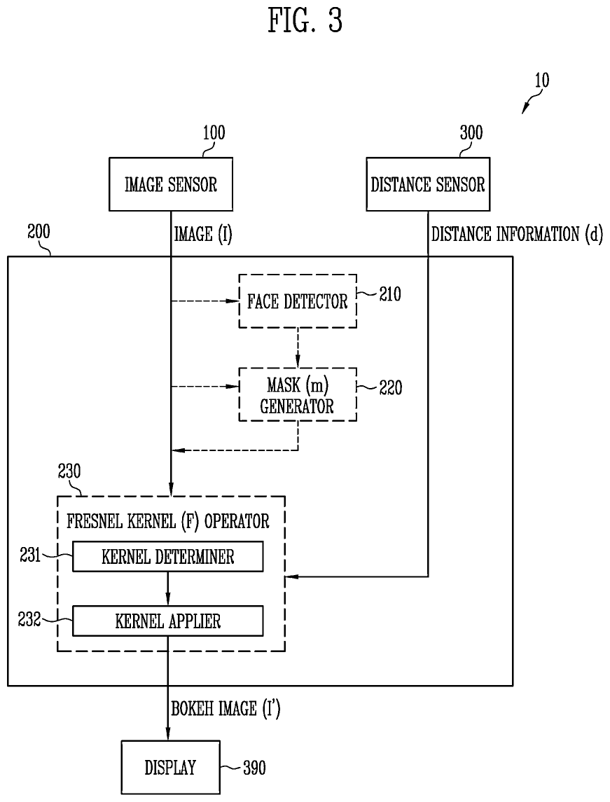

The image processor 200 may obtain the distance information of the captured scene from the distance sensor 300. The image processor 200 may apply a bokeh effect to an image received from the image sensor 100 using the distance information. A method of applying the bokeh effect is described later with reference to FIGS. 3 to 5.

Referring to FIG. 1, the image processor 200 may be implemented as a chip independent from the image sensor 100. In this case, a chip of the image sensor 100 and the chip of the image processor 200 may be implemented as one package, for example, a multi-chip package. However, the present disclosure is not limited thereto, and according to another embodiment of the present disclosure, the image processor 200 may be included as a part of the image sensor 100 and implemented as a single chip.

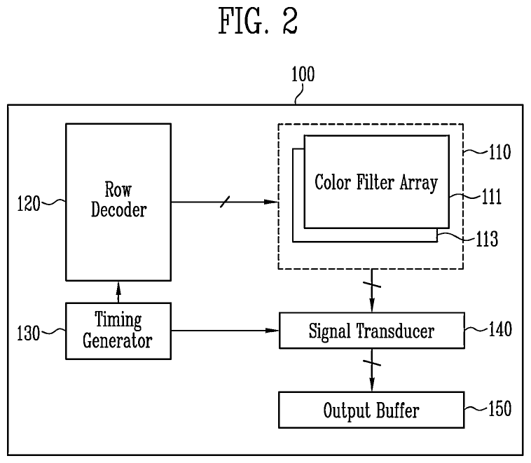

FIG. 2 is a diagram illustrating an image sensor according to an embodiment of the present disclosure.

Referring to FIG. 2, the image sensor 100 may include a pixel array 110, a row decoder 120, a timing generator 130, and a signal transducer 140. In addition, the image sensor 100 may further include an output buffer 150.

The pixel array 110 may include a plurality of pixels arranged in a row direction and a column direction. Each of the pixels may generate a pixel signal VPXs corresponding to an intensity of light incident on a corresponding pixel. The image sensor 100 may read out a plurality of pixel signals VPXs for each row of the pixel array 110. Each of the plurality of pixel signals VPXs may be an analog type pixel signal.

The pixel array 110 may include a color filter array 111. Each of the plurality of pixels may output a pixel signal corresponding to incident light passing through the corresponding color filter array 111.

The color filter array 111 may include color filters passing only a specific wavelength (for example, red, green, and blue) of light incident to each pixel. The pixel signal of each pixel may indicate a value corresponding to intensity of the light of the specific wavelength by the color filter array 111.

The pixel array 110 may include a photoelectric conversion layer 113 including a plurality of photoelectric conversion elements formed under the color filter array 111. Each of the plurality of pixels may generate a photocharge corresponding to incident light through the photoelectric conversion layer 113. The plurality of pixels may accumulate the generated photocharges and generate the pixel signal VPXs corresponding to the accumulated photocharges.

The photoelectric conversion layer 113 may include the photoelectric conversion element corresponding to each of the pixels. For example, the photoelectric conversion element may be at least one of a photo diode, a photo transistor, a photogate, or a pinned photo diode. The plurality of pixels may generate a photocharge corresponding to light incident on each pixel through the photoelectric conversion layer 113 and obtain an electrical signal corresponding to the photocharge through at least one transistor.

The row decoder 120 may select one row among a plurality of rows in which a plurality of pixels are arranged in the pixel array 110 in response to an address and control signals output from the timing generator 130. The image sensor 100 may read out pixels of a row included in a specific row among the plurality of pixels included in the pixel array 110 under control of the row decoder 120.

The signal transducer 140 may convert the plurality of analog type pixel signals VPXs into a plurality of digital type pixel values DPXs. The signal transducer 140 may perform correlated double sampling (CDS) on each of signals output from the pixel array 110 in response to the control signals output from the timing generator 130, and output each of digital signals by analog-digital converting each of signals obtained by the CDS. Each of the digital signals may be signals corresponding to the intensity of the incident light passing through the corresponding color filter array 111.

The signal transducer 140 may include a CDS block and an analog to digital converter (ADC) block. The CDS block may sequentially sample and hold a set of a reference signal and an image signal provided from a column line included in the pixel array 110. That is, the CDS block may obtain a signal in which readout noise is reduced by using a level difference between the reference signal corresponding to each of the columns and the image signal. The ADC block may output pixel data by converting an analog signal for each column output from the CDS block into a digital signal. To this end, the ADC block may include a comparator and a counter corresponding to each column.

The output buffer 150 may be implemented with a plurality of buffers storing the digital signals output from the signal transducer 140. Specifically, the output buffer 150 may latch and output pixel data of each column unit provided from the signal transducer 140. The output buffer 150 may temporarily store the pixel data output from the signal transducer 140 and sequentially output the pixel data under the control of the timing generator 130. According to an embodiment of the present disclosure, the output buffer 150 may be omitted.

FIG. 3 is a diagram illustrating configurations included in a device according to an embodiment of the present disclosure.

Referring to FIG. 3, the device 10 may include the image sensor 100, the distance sensor 300, the image processor 200, and a display 390. The image processor 200 may include a face detector 210, a mask generator 220, and a Fresnel kernel operator 230.

The image sensor 100 may obtain an image I through the pixel array 110 and may provide the obtained image I to the image processor 200. The image I may indicate the image data including the plurality of pixel values DPXs described with reference to FIGS. 1 and 2.

The distance sensor 300 may obtain distance information d for a captured scene and may provide the obtained distance information d to the image processor 200. In the present disclosure, the distance information d may indicate information on a distance between at least one subject included in the image I and the device 10.

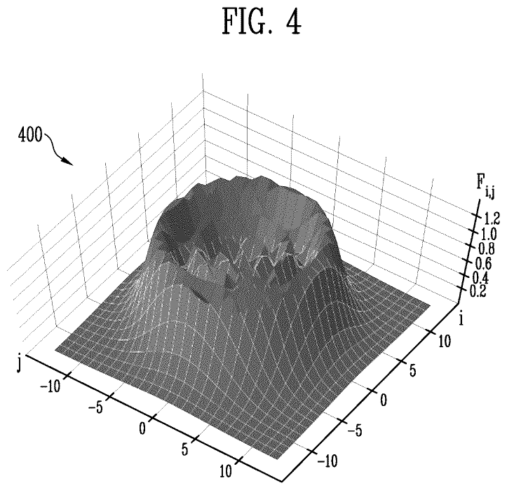

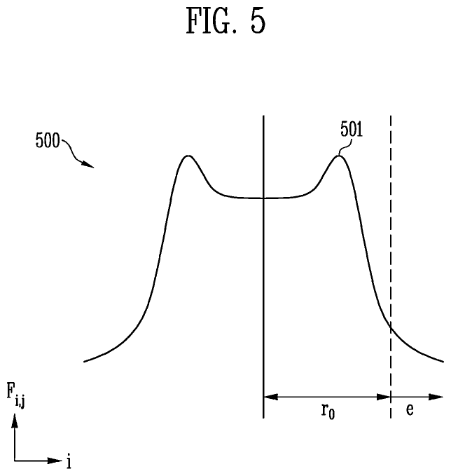

The image processor 200 may generate a bokeh image I′ based on the image I obtained from the image sensor 100 and the distance information d obtained from the distance sensor 300. The image processor 200 may apply a bokeh effect to the image I through the Fresnel kernel operator 230 and obtain the bokeh image I′ to which the bokeh effect is applied. The Fresnel kernel operator 230 may generate the bokeh image I′ by performing a convolution operation on the image I using a Fresnel kernel F. The Fresnel kernel F is described later with reference to FIGS. 4 and 5.

The Fresnel kernel operator 230 may include a kernel determiner 231 and a kernel applier 232. The image processor 200 may include the kernel determiner 231 determining a kernel to be applied to the image I and the kernel applier 232 generating and outputting the bokeh image I′ by blurring at least a partial area of the image I using the kernel. For example, the kernel determiner 231 may determine at least one of a shape, a size of an outer portion, or a size of a central portion of the Fresnel kernel F, by using at least one of color information of the image I or the distance information d obtained from the distance sensor 300. In addition, the kernel applier 232 may generate the bokeh image I′ by applying the kernel determined by the kernel determiner 231 to the image I.

The image processor 200 may detect a face included in the image I through the face detector 210. The face detector 210 may detect a position of the face based on the image I. For example, the face detector 210 may detect an area corresponding to the face using a Haar function or a Cascade classifier with respect to the image I.

The image processor 200 may divide the image I to a face area corresponding to the face and a background area corresponding to an area other than the face area through the mask generator 220. For example, the mask generator 220 may determine the face area based on the position of the face detected through the face detector 210. In the present disclosure, the face area may be referred to as a mask m.

The display 390 may display the bokeh image I′ received from the image processor 200. The device 10 may display and/or output the bokeh image I′ through the display 390. Through this, the device 10 may provide the bokeh image I′ to a user using the display 390. However, a description of the display 390 included in the device 10 is an example and does not limit the scope of the present disclosure. For example, even though the bokeh image I′ is transferred to the display 390 in FIG. 3, the image processor 200 may provide the bokeh image I′ to various configurations such as a memory or an application processor (AP) in addition to the display 390.

FIG. 4 is a diagram illustrating a Fresnel kernel according to an embodiment of the present disclosure. FIG. 5 is a diagram illustrating a cross section of a Fresnel kernel according to an embodiment of the present disclosure.

According to the present disclosure, the device 10 may generate the bokeh image I′ using the Fresnel kernel F that is different from a Gaussian kernel. The image processor 200 may determine the Fresnel kernel F through the kernel determiner 231 and perform convolution operation on the image I with the Fresnel kernel F through the kernel applier 232, to generate the bokeh image I′. A graph 400 of FIG. 4 illustrates an example of the Fresnel kernel F determined by the kernel determiner 231. A graph 500 of FIG. 5 illustrates a cross section of the Fresnel kernel F shown in FIG. 4.

The Fresnel kernel F of the present disclosure may be defined through Equation 1.

$${F}_{i , j \vert r = \sqrt{{i}^{2} + {j}^{2}} , - ( {r}_{0} + e ) \leq i , j \leq ( {r}_{0} + e )} = \qquad [ Equation 1 ]$$

$$\frac{1}{2} [ {\{ C ( \sqrt{\frac{π}{2 λ}} ( r - {r}_{0} ) ) + \frac{1}{2} \}}^{2} + {\{ S ( \sqrt{\frac{π}{z λ}} ( r - {r}_{0} ) ) + \frac{1}{2} \}}^{2} ]$$

In Equation 1, C(x) and S(x) may be Fresnel integral functions, and may be defined through Equation 2. In the present disclosure, because the kernel F_{i,j} is a function defined using a Fresnel integral function, the kernel F_{i,j} may be referred to as the Fresnel kernel.

$$C ( x ) = {\int }_{0}^{x} cos ( \frac{π {t}^{2}}{2} ) dt ; S ( x ) = {\int }_{0}^{x} sin ( \frac{π {t}^{2}}{2} ) dt \qquad [ Equation 2 ]$$

Referring to Equation 1, the Fresnel kernel F_{i,j} may include a first parameter z, a second parameter λ, a third parameter e, and a fourth parameter r₀. The image processor 200 (for example, the kernel determiner 231) may determine the first parameter z, the second parameter λ, the third parameter e, and the fourth parameter r₀, and determine the Fresnel kernel F_{i,j} based on the determined parameters. The image processor 200 (for example, the kernel applier 232) may generate the bokeh image I′ using the determined Fresnel kernel F_{i,j}.

The first parameter z may be a parameter determined based on the distance from the subject to which focus is set in the captured scene. The image processor 200 may determine the first parameter z based on the distance or (a focus distance) of the subject to which the focus is set. When a distance to a position to which the focus is set is z₀, the image processor 200 may normalize z₀ to 10 mm to determine the first parameter z. That is, the first parameter z may be calculated through an equation z=z₀ [mm]/10 [mm]. For example, when the distance between the subject to which the focus is set and the device 10 is 500 mm, the image processor 200 may determine that the first parameter z=500/10=50. In an embodiment, the image processor 200 may obtain the distance information of the captured scene from the distance sensor 300 and determine the first parameter z based on the distance information.

The second parameter λ may be a parameter determined

based on the color corresponding to the pixel data included in the image. For example, the second parameter λ may be a parameter determined based on a color of a pixel to which the Fresnel kernel F_{i,j} is applied. The image processor 200 may determine the second parameter λ based on a wavelength of the color of the pixel to which the bokeh effect is applied. When a wavelength of a color of a pixel to be blurred is λ₀, the image processor 200 may normalize λ₀ to 1000 nm to determine the second parameter λ. That is, the second parameter λ may be calculated through an equation of λ=λ₀ [nm]/1000 [nm]. For example, when the color of the pixel to which the Fresnel kernel is applied is green (G) color, because λ₀=550 nm, the image processor 200 may determine that the second parameter λ=550/1000=0.55.

The third parameter e may be a parameter determined

based on the color corresponding to the pixel data included in the image. For example, the third parameter e may be a parameter determined based on a color of the pixel to which the Fresnel kernel F_{i,j} is applied. The image processor 200 may determine the third parameter e based on the wavelength of the color of the pixel to which the bokeh effect is applied. The image processor 200 may determine that a value obtained by dividing 4 times the wavelength of the color of the pixel to be blurred by 1000 nm is the fourth parameter e. For example, when the color of the pixel to which the Fresnel kernel is applied is green color, the image processor 200 may determine that the third parameter e=4×550/1000≈2.

The fourth parameter r₀ may be a parameter determined based on the distance to the captured scene. For example, the image captured by the device 10 may include a first subject to focus is set and a second subject to which focus is not set. Because the focus is set to the first subject, a distance between the first subject and the device 10 may match a distance (or a focus distance) at which the device 10 sets focus. When applying the Fresnel kernel F_{i,j} to an image area corresponding to the second subject, the image processor 200 may determine r₀ based on a distance difference between the first subject and the second subject. That is, the image processor 200 may calculate r₀ based on a distance d₀ between the subject to which the bokeh effect is applied and the focus distance. For example, when the distance between the subject and the focus distance is d₀, the image processor 200 may determine the fourth parameter r₀ through an equation of r₀=d₀ [mm]/10 [mm]. In an embodiment, the image processor 200 may obtain the distance information of the captured scene from the distance sensor 300 and determine the fourth parameter r₀ based on the distance information.

The image processor 200 (for example, the kernel applier 232) may obtain a bokeh image I′_{x,y} based on an image I_{i,j} through Equation 3. The image processor 200 (for example, the kernel applier 232) may obtain the bokeh image I′_{x,y} by applying the Fresnel kernel F_{i,j} to each pixel position to which the bokeh effect is applied.

I′_{x,y}=Σᵢⱼm_{i,j}F_{i,j}I_{i-x,j-y} [Equation 3]

The image processor 200 may adjust a bokeh intensity through Equation 4. For example, the image processor 200 may obtain an image I″_{x,y} of which the bokeh intensity is adjusted by multiplying the bokeh image I′_{x,y} by a weighted value wₖ.

I″_{x,y}=ΣₖwₖI′_{x,y}(r₀=dₖ) [Equation 4]

Referring to Equation 1 and the graph 500 of FIG. 5 together, the Fresnel kernel F_{i,j} may be determined by the first parameter z, the second parameter λ, the third parameter e, and the fourth parameter r₀. For example, the image processor 200 (for example, the kernel determiner 231) may determine a size and a shape of the Fresnel kernel F_{i,j} based on the first parameter z, the second parameter λ, the third parameter e, and the fourth parameter r₀.

The image processor 200 (for example, the kernel determiner 231) may determine the shape of the Fresnel kernel F_{i,j} based on the first parameter z and the second parameter λ. The image processor 200 may determine the shape of the Fresnel kernel F_{i,j} applied to a corresponding pixel, based on the first parameter z and the second parameter λ determined according to the pixel applied to the Fresnel kernel (the pixel to which the bokeh effect is applied, or the blurred pixel).

For example, the image processor 200 (for example, the kernel determiner 231) may determine a shape of a protrusion 501 of the Fresnel kernel F_{i,j} based on the first parameter z and the second parameter λ. The image processor 200 may determine the shape of the protrusion 501 of the Fresnel kernel F_{i,j} using at least one of the first parameter z or the second parameter λ. For example, the image processor 200 may determine at least one of the shape, a position, a height, a step difference, or the number of the protrusions 501 according to the first parameter z or the second parameter λ. The image processor 200 may adjust/control the shape of the Fresnel kernel F_{i,j} through at least one of the first parameter z or the second parameter λ.

The image processor 200 (for example, the kernel determiner 231) may determine a size of an outer portion of the Fresnel kernel F_{i,j} based on the third parameter e. Referring to FIG. 5, the image processor 200 may determine a size of an envelope portion of the Fresnel kernel F_{i,j} according to the third parameter e. The image processor 200 may increase the size of the outer portion of the kernel as the third parameter e increases, and may decrease the size of the outer portion of the kernel as the third parameter e decreases. The image processor 200 may control enlargement of the envelope portion of the kernel according to the third parameter e.

The image processor 200 (for example, the kernel determiner 231) may determine a size of a central portion of the Fresnel kernel F_{i,j} based on the fourth parameter r₀. Referring to FIG. 5, the image processor 200 may determine a diameter of the central portion of the Fresnel kernel F_{i,j} according to the fourth parameter r₀. The image processor 200 may increase the size of the central portion of the kernel as the fourth parameter r₀ increases, and may decrease the size of the central portion of the kernel as the fourth parameter r₀ decreases.

Referring to FIG. 5, the size of the kernel (or a diameter of the kernel) may be rote, which is a sum of the fourth parameter r₀ and the third parameter e.

According to the content described with reference to FIGS. 4 and 5, because the Fresnel kernel F_{i,j} is a kernel defined by reflecting a diffraction effect of the actual lens, the bokeh image I′ obtained by performing the convolution operation using the Fresnel kernel F_{i,j} may be an image in which the diffraction of the actual lens is reproduced. The device 10 may reproduce the diffraction of the actual lens by applying the bokeh effect through the Fresnel kernel F_{i,j}. Through this, it is difficult for the device 10 to capture the out focus image through the actual lens, but the device 10 may obtain the bokeh image I′ similar to the out focus image.

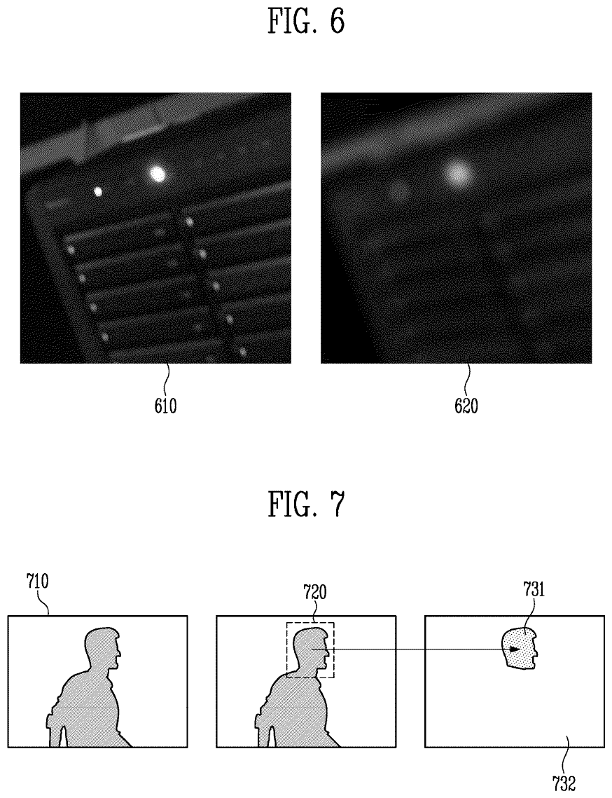

FIG. 6 is a diagram illustrating an example of a bokeh image generated according to an embodiment of the present disclosure.

Referring to FIG. 6, an image 610 may correspond to a partial area of the image I of FIG. 3, and a bokeh image 620 may correspond to a partial area of the bokeh image I′ of FIG. 3.

The image processor 200 may obtain the image I from the image sensor 100 and obtain the distance information from the distance sensor 300. The image I may include color information on a color of a specific pixel. The image processor 200 may determine the kernel F applied to the image I based on the distance information and the color information. For example, the image processor 200 may determine the first parameter z and the second parameter λ of the kernel F based on the distance information and the color information, and determine the shape of the kernel F based on the first parameter z and the second parameter λ. As another example, the image processor 200 may determine the first parameter z, the second parameter λ, the third parameter e, and the fourth parameter r₀ of the kernel F based on the distance information and the color information, and determine the shape and the size of the kernel F based on the first parameter z, the second parameter λ, the third parameter e, and the fourth parameter r₀. The image processor 200 may generate the bokeh image I′ in which a partial area (for example, the background area) of the image I is blurred using the determined kernel F.

Referring to FIG. 6, the image 610 and the bokeh image 620 may correspond to the blurred partial area (for example, a background area) of the bokeh image I′ of FIG. 3. The image processor 200 may obtain the bokeh image 620 obtained by blurring the image 610 using the kernel F. The image processor 200 may obtain the bokeh image 620 corresponding to the blurred background area by applying the kernel F to the image 610 corresponding to the background area of the captured scene.

The bokeh image 620 generated using the Fresnel kernel F may be an image in which the diffraction effect by the actual lens is reproduced. Therefore, compared to a bokeh image generated using a conventional Gaussian kernel, the bokeh image 620 according to the present disclosure may be more similar to the out focus image captured according to adjustment of the depth of field.

FIG. 7 is a diagram illustrating a method of dividing an image into a face area and a background area according to an embodiment of the present disclosure.

Referring to FIG. 7, an image 710 is an example of the image I obtained by the image processor 200 from the image sensor 100. The image processor 200 may obtain the image 710 in which the main subject is a person from the image sensor 100.

The image processor 200 may perform face detection on the image 710. For example, the image processor 200 may perform the face detection using a Haar function and/or a cascade classifier on the image 710.

The image processor 200 (for example, the face detector

210) may perform the face detection on the image 710 to identify a face detection area 720. The image processor 200 (for example, the face detector 210) may determine a position of the image 710 where it is determined that a face is included as the face detection area 720.

The image processor 200 (for example, the mask generator 220) may determine a face area 731 including at least some pixels in which a color difference between pixels is less than a threshold value among pixels included in the face detection area 720. For example, the image processor 200 may regard a color value (for example, an RGB value) of each pixel included in the face detection area 720 as a three-dimensional vector, and calculate a normalized cosine similarity with a neighboring pixel using the color value considered as the three-dimensional vector.

The image processor 200 may calculate a threshold value for determining the cosine similarity using a variance value previously set in the device 10 or an arbitrarily set variance value. The threshold value may be a value that is not affected by a luminance. The image processor 200 may determine an area where the color value is equal to or less than the threshold value is the same color, and areas where the color value is greater than the threshold value are different colors. The image processor 200 (for example, the mask generator 220) may determine an area determined as the same color among the pixels included in the face detection area 720 as the face area 731 (or the mask m). That is, the image processor 200 may divide and/or classify the pixels included in the face detection area 720 into pixels included in the face area 731 and other pixels by using the threshold value.

The image processor 200 (for example, the mask generator 220) may determine a remaining area other than the determined face area 731 as a background area 732. That is, the image processor 200 may divide the image 710 into the face area 731 corresponding to the face and the background area 732 corresponding to the area other than the face area 731.

The image processor 200 (for example, the kernel applier 232) may blur the background area 732 of the image 710 using the kernel F. The image processor 200 (for example, the kernel applier 232) might not apply the kernel F to the face area 731 corresponding to the main subject of the image 710, and apply the kernel F to the background area 732 other than the face area 731.

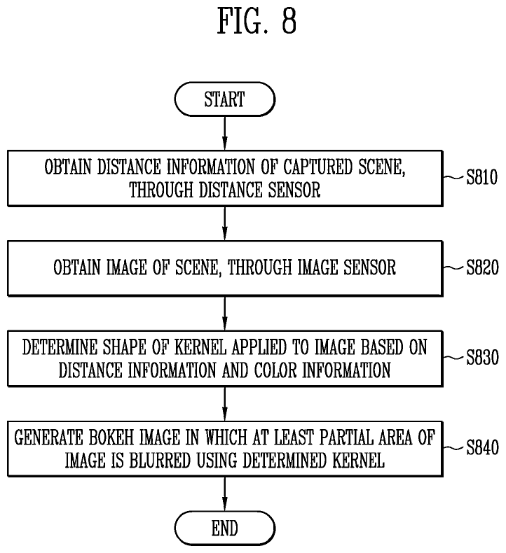

FIG. 8 is a flowchart illustrating a method of generating a bokeh image according to an embodiment of the present disclosure.

In step S810, the device 10 may obtain the distance information d of the captured scene, through the distance sensor 300. The distance information d may include information on a distance between each subject included in the captured scene and the device 10.

In step S820, the device 10 may obtain the image I of the scene through the image sensor 100. The image I may be an image in which a subject (for example, a face) in which focus is set appears clearly and a background area in which focus is not set appears relatively clearly.

In step S830, the device 10 may determine the shape of the kernel F applied to the image based on the distance information d and the color information of the image I. The color information may indicate the wavelength of the color of the pixel to which the kernel F is applied. For example, the device 10 may identify the distance to the subject to which the focus is set based on the distance information d, and determine the first parameter z using the distance to the subject to which the focus is set. The device 10 may determine the shape of the kernel F based on the first parameter z. As another example, the device 10 may identify the color of the pixel data included in the image I based on the color information, and determine the second parameter λ using the wavelength of the color. The device 10 may determine the shape of the kernel F based on the second parameter λ.

In step S840, the device 10 may generate the bokeh image I′ in which at least a partial area of the image I is blurred using the determined kernel. The device 10 may generate the bokeh image I′ in which the background area other than the main subject is blurred in the image I. For example, the device 10 might not apply the kernel F to the face area 731 identified in FIG. 7 and may apply the kernel F to the background area 732. Accordingly, the device 10 may obtain the bokeh image I′ in which the background area 732 of the image 710 is blurred.

What is claimed is:

1. An image processor comprising:
a kernel determiner configured to determine a shape of a kernel applied to an image based on at least one of distance information or color information; and
a kernel applier configured to output a bokeh image obtained by blurring at least a partial area of the image using the kernel.

2. The image processor of claim 1, wherein the kernel determiner determines the shape of the kernel using a first parameter determined based on a distance to a subject to which focus is set in a scene corresponding to the image.

3. The image processor of claim 1, wherein the kernel determiner determines the shape of the kernel using a second parameter determined based on a color corresponding to pixel data included in the image.

4. The image processor of claim 3, wherein the kernel determiner determines the second parameter based on a wavelength of the color.

5. The image processor of claim 1, wherein the kernel determiner determines a size of an outer portion of the kernel based on a third parameter determined based on a color corresponding to pixel data included in the image.

6. The image processor of claim 1, wherein the kernel determiner determines a size of a central portion of the kernel using a fourth parameter determined based on a distance to a scene corresponding to the image.

7. The image processor of claim 1, wherein the kernel is a Fresnel kernel.

8. The image processor of claim 1, further comprising:
a face detector configured to divide the image into a face area corresponding to a face and a background area corresponding to an area other than the face area.

9. The image processor of claim 8, wherein the face detector:
identifies a face detection area by performing face detection on the image; and
determines the face area including at least a portion of pixels for which a color difference is less than a threshold value among pixels included in the face detection area.

10. The image processor of claim 8, wherein the kernel applier generates the bokeh image by blurring the background area using the kernel.

11. An image processing device comprising:
a distance sensor configured to obtain distance information for a scene;
an image sensor configured to capture an image of the scene; and
an image processor configured to determine a shape of a kernel applied to the image based on the distance information and color information of the image, generate a bokeh image obtained by blurring at least a partial area of the image using the kernel, and output the generated bokeh image.

12. The image processing device of claim 11, wherein the image processor determines the shape of the kernel using a first parameter determined based on a distance to a subject to which focus is set in the scene.

13. The image processing device of claim 11, wherein the image processor determines the shape of the kernel using a second parameter determined based on a color corresponding to pixel data included in the image.

14. The image processing device of claim 11, wherein the image processor determines a size of an outer portion of the kernel based on a third parameter determined based on a color corresponding to pixel data included in the image.

15. The image processing device of claim 11, wherein the kernel is a Fresnel kernel.

16. An image processing method comprising:
obtaining distance information for a scene through a distance sensor;
capturing an image of the scene through an image sensor;
determining a shape of a kernel applied to the image based on the distance information and color information of the image; and
generating a bokeh image in which at least a partial area of the image is blurred using the determined kernel.

17. The image processing method of claim 16, wherein determining the shape of the kernel comprises determining the shape of the kernel using a first parameter determined based on a distance to a subject to which focus is set in the scene.

18. The image processing method of claim 16, wherein determining the shape of the kernel comprises determining the shape of the kernel using a second parameter determined based on a color corresponding to pixel data included in the image.

19. The image processing method of claim 16, further comprising:
determining a size of an outer portion of the kernel based on a third parameter determined based on a color corresponding to pixel data included in the image.

20. The image processing method of claim 16, further comprising:
determining a size of a central portion of the kernel using a fourth parameter determined based on a distance to the scene.
